(19) United States
(12) Patent Application Publication
(10) Pub. No.: US 2002/0138159 A1
(43) Pub. Date: Sep. 26, 2002

(54) Temperature responsive power supply to minimize power consumption of digital logic without reducing system performance

(76) Inventor: Lee W. Atkinson, Houston, TX (US)

Correspondence Address: Fletcher, Yoder & Van Someren, P.O. Box 692289, Houston, TX, 77269-2289, US

(21) Appl. No.: 09/817,534

(22) Filed: Mar. 26, 2001

(51) Int. Cl. G05B 11/01; G05B 9/02

(52) U.S. Cl. 700/21; 700/12; 700/79

(57) ABSTRACT

The present technique is associated with performance control for a computing device, such as a computer system. The technique provides temperature-responsive adjustments for a power supply based on a desired computing performance. In one aspect, the technique minimizes power consumption of the computing device while substantially maintaining the desired computing performance.

### FIELD OF THE INVENTION

The present technique relates generally to the field of computer systems, and more specifically, to power and thermal control systems. The present technique is a system and method for controlling a power supply based on a temperature reading for the computer system, and for adjusting the power supply to minimize power consumption without reducing system performance.

### BACKGROUND OF THE INVENTION

Computer systems and other electronic devices generally comprise a variety of circuits, processors, memory and power supplies to perform desired functions. Although operating performance (e.g., clock speed) is an important design concern, power conservation and thermal management are established criteria which are becoming increasingly important for compact, mobile and battery operated computing devices (e.g., laptop and palmtop computers). The performance of portable computing devices generally lags stationary systems for a variety of design considerations, such as size constraints, limited power supplies (e.g., batteries), and limited cooling systems. For example, a portable computing device may utilize a 200 mhz processor rather than a 600 mhz processor due to higher power consumption and/or heat generation associated with the higher performance processor. Due to these design considerations, designers often provide a balance between performance and mobile operating time for portable computing devices.

Accordingly, there is a need for a technique for reducing power consumption of computing devices while maintaining a desired system performance. In one aspect, a technique is needed for integrally controlling power consumption, system performance, and temperature for the computing device.

### SUMMARY OF THE INVENTION

The present technique is associated with performance control for a computing device, such as a computer system. The technique provides temperature-responsive adjustments for a power supply based on a desired computing performance. In one aspect, the technique minimizes power consumption of the computing device while substantially maintaining the desired computing performance.

According to an aspect of the present technique, a method is provided for controlling performance of a computer system. The method comprises controlling a power supply to provide power for operating an electronic device based on an evaluation of a monitored parameter against a performance criteria for the electronic device. The performance criteria comprise a relationship between temperature and power input for the electronic device.

According to another aspect of the present technique, a system is provided for minimizing power consumption of digital logic. The system comprises a sensor signal, a control module, and a control signal. The sensor signal is configured for determining temperature of the digital logic. The control module includes control criteria for evaluating the sensor signal. The control criteria comprise operating relationships for the digital logic including an inverse relationship between temperature and computing performance and a direct relationship between voltage and computing performance. The control signal is configured for adjusting a power supply for the digital logic to minimize power consumption and to provide a desired computing performance as the temperature varies for the digital logic.

### BRIEF DESCRIPTION OF THE DRAWINGS

The invention will hereafter be described with reference to the accompanying drawings, wherein like reference numerals denote like elements, and:

FIG. 1 is a diagram illustrating an exemplary embodiment of the present technique comprising an electronic device having a power control assembly;

FIG. 2 is a graph of operating frequency versus operating voltage for a low temperature TL, a medium temperature TM, and a high temperature TH;

FIGS. 3 and 4 are diagrams illustrating exemplary embodiments of the present technique comprising a feedback assembly for control between a power supply and an electronic device.

### DETAILED DESCRIPTION OF SPECIFIC EMBODIMENTS

The present technique comprises a system for reducing the power consumption of a computing device having an integrated circuit (e.g., a CMOS integrated circuit, and particularly a processor) without compromising performance. It does this by optimizing the operational core voltage for the device based on temperature. When the device is cool, the operational voltage is reduced to save power, lower thermal dissipation, and increase the expected life of the device without compromising performance.

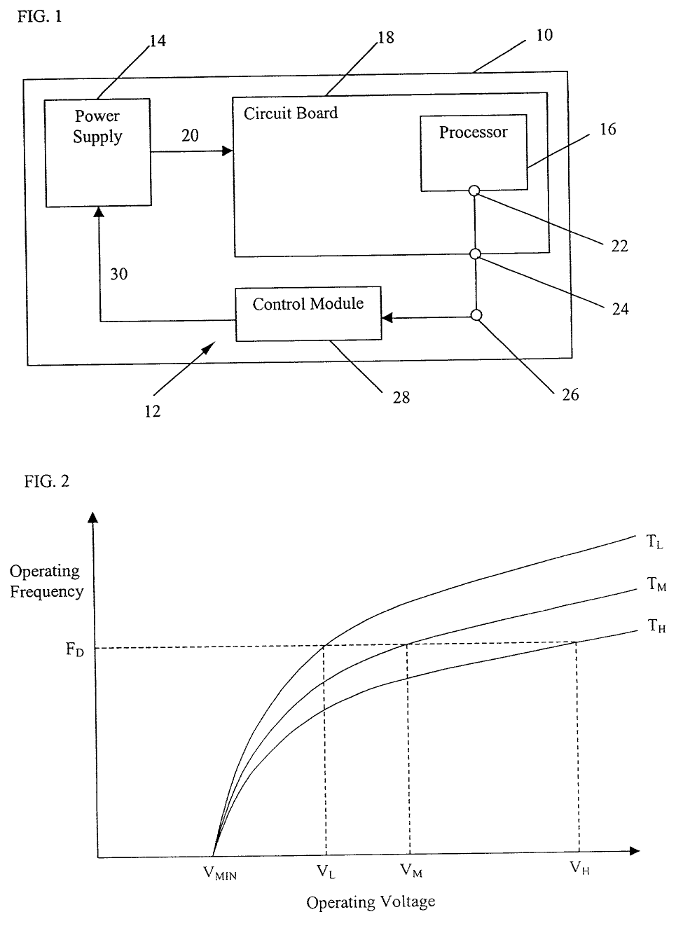

FIG. 1 is a diagram illustrating an exemplary embodiment of the present technique comprising an electronic device 10 having a power control assembly 12. The electronic device 10 may embody a computer system (e.g., desktop or portable), a computing device (e.g., having a processor), or a variety of other electronic devices benefiting from power control based on a temperature reading. As illustrated, the electronic device 10 includes the power control assembly 12, a power supply 14, and a processor 16 (e.g., a CPU) mounted on a circuit board 18 (e.g., a digital logic circuit). The power supply 14 provides an output 20 (e.g., a voltage) to the circuit board 18 and/or the processor 16 for operating the electronic device 10.

The power control assembly 12 may comprise a variety of electronic circuits and devices, instruments and gauges, and other hardware and software for determining temperature and adjusting the output 20 from the power supply 14. For example, the power control assembly 12 may comprise a plurality of measurement points, such as points 22, 24 and 26 at the processor 16, the circuit board 18 and within the electronic device 10, respectively, for obtaining a reading of a desired criteria (e.g., temperature). The power control assembly 12 also may comprise a control module 28 for receiving the reading, analyzing the desired criteria, and transmitting a control signal 30 to the power supply 14.

In one aspect, the reading comprises a temperature reading obtained from a thermometer assembly (e.g., a thermistor, a thermocouple, or a thermal sensor chip). The reference temperature can be obtained either directly or indirectly, and the thermometer assembly may comprise a plurality of components and/or software for determining temperature based on the reading. Once the power control assembly 12 determines the reference temperature, the control signal 30 is transmitted to the power supply 14 to adjust the output 20. For example, the power control assembly 12 may tailor the control signal 30 to the reference temperature obtained at point 22 on the processor 16, such that the control signal 30 causes the power supply 14 to change the output 20 to obtain a desired performance of the processor 16 and/or the electronic device 10 (e.g., a desired operating speed, a desired power consumption rate, etc.). In this exemplary embodiment, the power control assembly 12 is configured to minimize power consumption by lowering the output 20 as the reference temperature decreases. The power supply 14 may be adjusted continuously, or in steps, according to a desired frequency and the necessary voltage to obtain that frequency at the reference temperature. The power consumption relationship is explained in detail below.

In any digital logic device, power consumption and thermal dissipation are directly related to three variables: (1) the speed of logic state transitions or basic “clock speed,” (2) the parasitic “capacitance” of the circuit which is associated with the semiconductor process, and (3) the voltage swing or “operating voltage” required for a complete logical transition. Accordingly, the following equation may be used to determine power consumption based on these variables.

Power Consumption=Frequency*Capacitance*Voltage*2

The frequency parameter is a function of both the clock speed and the amount of logic in a circuit, both of which have steadily increased along with the requirement for increased performance. However, the trend towards smaller electronics also impacts the capacitance parameter, which is a function of the transistor geometry in a circuit. For example, capacitance is substantially reduced by replacing a 0.18 micron transistor with a 0.13 micron transistor. This reduction in capacitance provides lower power consumption. Although the frequency and capacitance parameters both affect the power consumed by a particular device, the voltage parameter is a relatively important factor because the operating voltage must be squared in the power consumption equation.

A variety of techniques can be utilized to lower power consumption. For example, the voltage and/or frequency may be lowered to increase operating time for a portable computing device. A “battery optimized” mode of operation may be provided at a low operating voltage and frequency (e.g., 1.35 volts and 400 mhz speed), while a performance oriented “AC Optimized mode” may be set at a higher voltage and frequency (e.g., 1.60 volts and 600 mhz). In this example, the voltage parameter alone causes a 40% change in power consumption. Although the frequency and voltage parameters can be mutually adjusted to decrease power consumption, it would be desirable to decrease voltage while maintaining performance levels.

The maximum reliable operating speed of a logic device (e.g., a semiconductor or digital logic device) is physically dependent on the operating voltage and temperature of the device. The operating speed generally increases with voltage and decreases with temperature. Below a minimum operating voltage (e.g., 1.2 volts), the logic device cannot operate because it will not conduct current. The minimum operating voltage is directly related to transistor physics and the circuit structure of the logic device. Once the minimum operating voltage is exceeded, the maximum reliable operating speed of the device increases with the core operating voltage. The temperature of the device also affects the maximum reliable operating speed, because the effective gain and output of the transistors generally decreases with temperature and affects the critical timing inside the device. Accordingly, it is desirable to lower the temperature to raise the maximum reliable operating speed.

The operation of a processor (e.g., CPU) is dynamic. The amount of power consumption can widely vary from as little as 300 milliwatts to over 30 watts instantaneously. If the processor transitions from a modest load to a relatively low load (e.g., an idle mode), the output of a power supply will relax and go to a slightly higher value than nominal (e.g., increase from a nominal voltage of 1.60 v to 1.65 v). Likewise, a sudden increase to intense loading will cause the output of the power supply to droop somewhat (e.g., from the nominal 1.60 v to 1.55 v). To correct this load variation, a power supply feedback can be provided to respond to the power consumption variation and adjust the voltage back to the nominal voltage. The present technique addresses a variety of power management concerns, including those mentioned above, which may be separately or integrally monitored and controlled by the power control assembly 12. For example, the power control assembly 12 may be configured to adjust an output of the power supply based on temperature, voltage, resistance, performance, and other operating parameters of the integrated circuit, the processor, the electronic components of the system, the software applications, and ambient conditions. As described above with reference to FIG. 1, the present technique involves obtaining a reference temperature to control the output 20 of the power supply 14, thereby controlling the power consumption and performance level of the electronic device 10.

Power consumption and thermal generation are important to battery life and to the reliability of the electronic device 10 (e.g., a digital logic device). For example, a temperature increase of 10° C. in the electronic device can reduce the life of a chip by 50%. In typical thermal designs, the temperature of the chip generally increases about 3° C. for every additional watt of power consumed. Accordingly, the effective reliable life of the device may only be 70% of its expected life at a lower power level. Regardless of the performance level (e.g., frequency), a lower voltage for an electronic device (e.g., the electronic device 10) generally provides lower thermal dissipation and slightly increased longevity.

FIG. 2 is a graph of the operating frequency versus operating voltage for a low temperature T_{L}, a medium temperature T_{M}, and a high temperature T_{H}. As illustrated, the operating frequency generally increases with the operating voltage, and decreases with the temperature. The present technique utilizes this relationship, and obtains the actual operating temperature (e.g., the reference temperature) of the electronic device 10 to responsively adjust the operating voltage to a minimum reliable value based on a desired operating performance. As illustrated in FIG. 2, the desired operating performance is set to a desired operating frequency F_{D}, which the present technique substantially maintains by adjusting the operating voltage in response to temperature variations. At the high temperature T_{H}, the operating voltage is set to V_{H}. As the electronic device 10 cools to a lower temperature, the power control assembly 12 adjusts the operating voltage to a lower voltage. For example, the operating voltage is set to V_{M} at the medium temperature T_{M}, and is set to V_{L} at the low temperature T_{L}.

In a system with very low power requirements (e.g., at V_{L}), the operating temperature may be as low as 40° C. at the low temperature T_{L}. In a system with moderate loading (e.g., at V_{M}), the operating temperature may be around 70° C. at the medium temperature T_{M}. In a system with relatively intense loading (e.g., V_{H}), the power consumption and thermal dissipation are both relatively high compared to the low and medium operating voltages V_{L} and V_{M}. However, the present technique provides reliable operation of the electronic device 10 maintained throughout the temperature range T_{L} through T_{H}. The power control assembly 12 dynamically responds to temperature variations, and ensures a substantially consistent performance level (e.g., operating frequency) while reducing power consumption for low temperature and/or low load conditions of the electronic device.

Note also, that the actual voltages applied to the electronic device 10 depend on characterization of the device based on temperature. For example, designers may test the devices up to a “worst case” scenario of a maximum loading and temperature (e.g., 90-100° C.), and then provide a factor of safety to ensure reliability. In the present technique, the power control assembly 12 may be configured to capture a portion of this factor of safety when necessary to increase performance of the electronic device 10. This is particularly advantageous for portable electronic devices (e.g., a laptop computer), which could benefit from the tradeoff between power consumption and performance when coupled to a continuous power source.

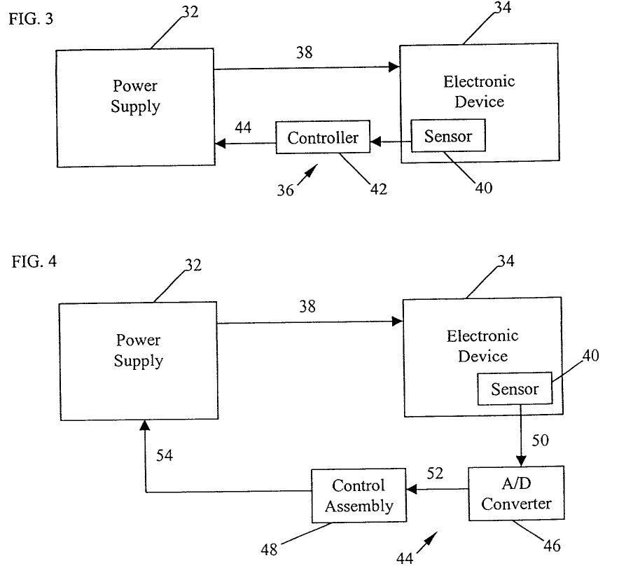

FIG. 3 is a diagram illustrating an exemplary embodiment of the present technique comprising a power supply 32, an electronic device 34 and a feedback assembly 36. As illustrated, the power supply 32 provides an output 38 (e.g., voltage) to the electronic device 34 (e.g., a computer system, a processor, digital logic, etc.) for operating the electronic device 34. The feedback assembly 36 may comprise a variety of electronics, instruments, gauges, sensors, and other components for monitoring the electronic device 34 and for adjusting the output 38 from the power supply 32. As illustrated, the feedback assembly 36 comprises a sensor 40 for obtaining a desired reading (e.g., temperature, voltage, resistance, etc.) on or within the electronic device 34, and a controller 42 for analyzing the desired reading and for transmitting a feedback signal 44 to the power supply 32.

The present technique utilizes a thermometer device to determine the reference temperature. The sensor 40 may include a thermistor, a thermocouple, or a thermal sensor chip such as those provided by Maxim Integrated Products, Inc., Sunnyvale, California, USA. After the feedback assembly 36 determines the reference temperature, the feedback assembly 36 evaluates the reference temperature against a temperature-voltage relationship (e.g., desired voltage versus temperature) and provides the feedback signal 30 to the power supply 32 to adjust the output 38 accordingly. Thus, the present technique manages the output 38 according to the reference temperature to ensure consistent performance and minimal power consumption of the electronic device 34. The power supply 32 can be adjusted continuously, or in steps, according to a desired frequency and the voltage necessary to substantially achieve that frequency at the reference temperature.

FIG. 4 is a diagram illustrating an exemplary embodiment of the present technique comprising the power supply 32, the electronic device 34 and a power management system 44. As illustrated, the power supply 32 provides the output 38 to power and operate the electronic device 34. The power management system 44 may comprise a variety of electronics, sensors, software, converters, and other components for monitoring the electronic device 34 and for adjusting the output 38 from the power supply 32. As illustrated, the power management system 44 includes the sensor 40 for determining the reference temperature of the electronic device 34. The sensor 40 can be integrally coupled to the electronic device 34 (e.g., to a processor, circuit board, etc.), or it can be provided with the power management system 44 for disposal within the electronic device 34. In the illustrated embodiment, the sensor 40 is an analog thermometer device, such as a thermistor (e.g., a transistor whose resistance varies with temperature), and the power management system 44 also includes an analog to digital converter 46 and a control assembly 48.

The sensor 40 provides an analog reading 50 to the analog to digital converter 46, which then converts the analog reading 50 to a digital reading 52 for analysis by the control assembly 48. For example, Maxim Integrated Products, Inc. (Sunnyvale, Calif., USA) provides several units that may be used for the digital converter 46, such as the Maxim “Max1617” or “Max1617A.” The digital converter 46 also may be configured to compare the analog reading 50 against one or more relevant readings (e.g., every 10° C., an over-temperature reading, an under-temperature reading, etc.), and then transmit the digital reading 52 (or an alarm signal) to the control assembly 48 when the analog reading 50 crosses the relevant reading. The digital converter 46 also may be programmable, and may allow selection of the relevant readings, conversion factors for the a/d conversion, and a variety of other parameters.

The control assembly may comprise a variety of hardware and digital logic for analyzing the digital reading 52, but in this embodiment, the control assembly 48 utilizes a software routine to analyze the digital reading 52 and to determine an appropriate correction for the power supply 32. For example, the software routine can include an equation or table characterizing the relationship illustrated in FIG. 2 for the particular electronic device 34. An exemplary table may comprise a plurality of temperature ranges (e.g., 0-40° C., 40-70° C., and 70-100° C.) and corresponding settings for the output 38 (e.g., 1.40 v, 1.50 v, and 1.60 volts). The table can also be configured in units of the digital reading 52, or the control assembly 48 can provide any necessary conversion factors for evaluating the digital reading 52 in terms of temperature. Accordingly, the control assembly 48 (e.g., the software routine) provides a control signal 54 to the power supply 32 to substantially achieve the desired performance level (e.g., frequency) and minimize power consumption.

Note also, that the control assembly 48 or the power supply 32 may comprise a programmable logic device to allow variation and adjustment of the output 38 from the power supply 32. For example, Maxim Integrated Products, Inc. (Sunnyvale, Calif., USA) provides several units that may be used for the programmable logic device, such as the Maxim “Max1710,” “Max1711,” and “Max1712.” The programmable logic device can be provided with the power management system 44 for coupling with the power supply 32, or it can be an integral part of the power supply 32 and/or the control assembly 48. Moreover, the embodiments discussed above can be partially or entirely integrated into a power supply, an electronic circuit (e.g., a motherboard and/or processor), or another electronic device, or it can embody a separate package/system tailored or programmable for a particular application.

According to the embodiments illustrated in FIGS. 1-4, the present technique provides an exemplary method for controlling performance (e.g., power consumption, maximum reliable operating speed or frequency, mobile operating time or battery life) of a computer system (e.g., a desktop, portable, laptop, or palmtop computer). The method comprises controlling a power supply (e.g., a DC supply, a battery supply, etc.) to provide a desired supply (e.g., power or voltage) for operating an electronic device (e.g., a processor, digital logic, or the computer system) based on an evaluation of a monitored parameter against a performance criteria for the electronic device. The performance criteria comprise a relationship between temperature and power input for the electronic device. For example, the performance criteria may comprise performance data, a performance table, or a power equation for solving power or voltage as a function of temperature and/or the desired performance (e.g., a clock speed specification of a processor).

Other aspects of the technique may comprise obtaining (e.g., receiving, sensing, calculating, etc.) the monitored parameter to determine an operating temperature of the electronic device. The monitored parameter may be sensed on a processor for the electronic device. Depending on the type of sensor used, the technique can include converting the monitored parameter to units of temperature for the electronic device. For example, an A/D converter may be provided for converting an analog signal into a temperature reading.

The monitored parameter can be evaluated against the performance criteria using a logic assembly (e.g., a logic circuit, a routine, a processor, etc.), a data set, a control table, a power equation, or other suitable evaluation techniques. For the performance criteria, the relationship is based on an inverse relationship between operating temperature and operating speed and a direct relationship between operating voltage and operating speed. For example, the power equation may be derived from the indirect and direct relationships, such that operating voltage can be determined based on operating temperature. In the evaluation, the desired operating speed may be necessary to determine the desired supply for maintaining the desired operating speed.

Once the desired supply is determined or calculated, then a control signal can be provided to adjust the power supply to the desired supply. The technique may also include adjusting the desired supply to substantially maintain a desired operating speed as the monitored parameter indicates a changing operating temperature of the electronic device. Moreover, the power supply can be adjusted (e.g., reduced) to minimize power consumption and to maintain a relatively consistent computing performance as the monitored parameter indicates a changing (e.g., decreasing) operating temperature of the electronic device. If a programmable power supply is provided, then the control assembly can adjust the desired supply as the monitored parameter indicates a changing operating temperature of the electronic device.

Other aspects of the technique may comprise a method for controlling operational parameters of a computer system. The technique may include obtaining a sensor reading to determine an operating temperature, analyzing the sensor reading based on performance relationships for the computer system, determining a desired voltage level for the computer system based on a desired performance, and providing a control signal configured for adjusting a power supply for the computer system to the desired voltage level. The performance relationships comprise an inverse relationship between temperature and performance and a direct relationship between voltage and performance. The sensor reading can be analyzed with a digital logic device, software, data sets or tables, equations, or other suitable evaluation techniques configured to determine the desired voltage level at the sensor reading. In any of these techniques, the analysis is based on the performance relationships. Also, the technique may comprise providing a temperature responsive control assembly configured to adjust the desired voltage level for the computer system as the operating temperature varies during operation of the computer system.

Another aspect of the technique can include a method of performance control for an electronic device having a processor. The technique may comprise providing a control assembly configured for monitoring an operating temperature and responsively adjusting an operating voltage as the operating temperature varies in the electronic device. The control assembly has control criteria comprising a desired operating speed, an inverse relationship between operating temperature and operating speed, and a direct relationship between operating voltage and operating speed. The control assembly can be coupled to a sensor on the processor (or other desired locations) for obtaining the operating temperature. A logic unit also may be provided for determining a desired operating voltage based on the control criteria. Moreover, a control program can be provided to complement or replace the logic unit.

While the invention may be susceptible to various modifications and alternative forms, specific embodiments have been shown by way of example in the drawings and have been described in detail herein. However, it should be understood that the invention is not intended to be limited to the particular forms disclosed. For example, the present technique is applicable to a variety of electronic devices, and may comprise various components and control techniques (e.g., open and closed feedback) configured to monitor an operating parameter (e.g., temperature) of the electronic device and adjust the power supply based on the operating parameter. Accordingly, the invention is intended to cover all modifications, equivalents, and alternatives falling within the spirit and scope of the invention as defined by the following appended claims.

What is claimed is:

1. A method for controlling performance of a computer system, comprising controlling a power supply to provide a desired supply for operating an electronic device based on an evaluation of a monitored parameter against a performance criteria for the electronic device, wherein the performance criteria comprise a relationship between temperature and power input for the electronic device.

2. The method of claim 1, comprising obtaining the monitored parameter to determine an operating temperature of the electronic device.

3. The method of claim 1, comprising sensing the monitored parameter on a processor for the electronic device.

4. The method of claim 1, comprising evaluating the monitored parameter against the performance criteria, wherein the relationship is based on an inverse relationship between operating temperature and operating speed and a direct relationship between operating voltage and operating speed.

5. The method of claim 4, wherein evaluating the monitored parameter against the performance criteria comprises analyzing the monitored parameter with a logic assembly configured to determine the desired supply based on the monitored parameter, wherein the logic assembly comprises logic based on the relationship.

6. The method of claim 4, wherein evaluating the monitored parameter against the performance criteria comprises searching a control table for the desired supply based on the monitored parameter, wherein the control table comprises a plurality of data sets based on the relationship.

7. The method of claim 4, wherein evaluating the monitored parameter against the performance criteria comprises solving a power equation for the desired supply, wherein the power equation is a function of the monitored parameter and is derived from the indirect relationship and the direct relationship.

8. The method of claim 1, comprising providing a control signal configured to adjust the power supply to the desired supply, wherein the control signal is based on the evaluation.

9. The method of claim 1, wherein controlling the power supply to provide the desired supply comprises adjusting the desired supply to substantially maintain a desired operating speed as the monitored parameter indicates a changing operating temperature of the electronic device.

10. The method of claim 1, wherein controlling the power supply to provide the desired supply comprises adjusting the desired supply to minimize power consumption and to maintain a relatively consistent computing performance as the monitored parameter indicates a changing operating temperature of the electronic device.

11. The method of claim 10, wherein adjusting the desired supply comprises reducing the desired supply as the monitored parameter indicates a decreasing operating temperature of the electronic device.

12. The method of claim 1, comprising programming a programmable power supply to adjust the desired supply as the monitored parameter indicates a changing operating temperature of the electronic device.

13. The method of claim 1, comprising integrating a temperature responsive control assembly into the computer system, wherein the temperature responsive control assembly is configured to adjust the desired supply for a central processor based on the monitored parameter, and the monitored parameter is obtained from a temperature sensor.

14. A method for controlling operational parameters of a computer system, comprising:
obtaining a sensor reading to determine an operating temperature;
analyzing the sensor reading based on performance relationships for the computer system, the performance relationships comprising an inverse relationship between temperature and performance and a direct relationship between voltage and performance;
determining a desired voltage level for the computer system based on a desired performance; and
providing a control signal configured for adjusting a power supply for the computer system to the desired voltage level.

15. The method of claim 14, comprising sensing the operating temperature on a processor for the computer system.

16. The method of claim 14, comprising converting the sensor reading to provide the operating temperature.

17. The method of claim 14, comprising analyzing the sensor reading with a digital logic device configured to determine the desired voltage level at the sensor reading, wherein the digital logic device has logic derived from the performance relationships.

18. The method of claim 14, comprising analyzing the sensor reading with a control program configured to determine the desired voltage level at the sensor reading, wherein the control program has analysis routines derived from the performance relationships.

19. The method of claim 14, comprising adjusting the power supply to relatively consistently provide the desired performance as the operating temperature varies during operation of the computer system.

20. The method of claim 14, comprising adjusting the power supply to minimize power consumption for the desired performance as the operating temperature varies during operation of the computer system.

21. The method of claim 20, wherein adjusting the power supply comprises reducing the desired voltage level as the operating temperature decreases during operation of the computer system.

22. A method of performance control for an electronic device having a processor, comprising providing a control assembly configured for monitoring an operating temperature and responsively adjusting an operating voltage as the operating temperature varies in the electronic device, wherein the control assembly has control criteria comprising a desired operating speed, an inverse relationship between operating temperature and operating speed, and a direct relationship between operating voltage and operating speed.

23. The method of claim 22, comprising providing a sensor to determine the operating temperature.

24. The method of claim 22, comprising coupling the control assembly to the processor.

25. The method of claim 22, comprising coupling the control assembly to a sensor on the processor for obtaining the operating temperature.

26. The method of claim 22, comprising providing a logic unit configured to determine a desired operating voltage based on the control criteria.

27. The method of claim 22, comprising providing a control program configured to determine a desired operating voltage based on the control criteria

28. The method of claim 22, comprising relatively consistently maintaining the desired operating speed as the operating temperature varies in the electronic device.

29. The method of claim 22, comprising minimizing power consumption at a relatively consistent operating speed of the processor as the operating temperature varies in the electronic device.

30. The method of claim 22, comprising providing a programmable power supply configured to responsively adjust the operating voltage as the operating temperature varies in the electronic device

31. A system for minimizing power consumption of digital logic, comprising:
a sensor signal configured for determining temperature of the digital logic;
a control module having control criteria for evaluating the sensor signal, wherein the control criteria comprise operating relationships for the digital logic comprising an inverse relationship between temperature and computing performance and a direct relationship between voltage and computing performance; and
a control signal configured for adjusting a power supply for the digital logic to minimize power consumption and to provide a desired computing performance as the temperature varies for the digital logic.

32. The system of claim 31, comprising a temperature sensor configured to provide the sensor signal.

33. The system of claim 31, wherein the temperature sensor is positioned for monitoring temperature of a processor for the digital logic.

34. The system of claim 31, comprising an analog to digital converter configured for converting the sensor signal to units of temperature.

35. The system of claim 31, wherein the control module comprises a control program comprising the control criteria and a routine utilizing the control criteria for determining a desired operating voltage based on the sensor signal and the desired computing performance.

36. The system of claim 31, wherein the control module is coupled to a processor for the digital logic.

37. The system of claim 31, wherein the desired computing performance is a desired maximum operating speed.

38. The system of claim 31, comprising a programmable power supply configured to responsively adjust the voltage as the temperature varies to substantially maintain the desired computing performance.

39. A system for increasing mobile operating time for a portable computing device, comprising:
a sensor for monitoring an operating temperature;
control criteria for evaluating the operating temperature, wherein the control criteria comprise operating relationships for the portable computing device comprising an inverse relationship between operating temperature and processing speed and a direct relationship between operating voltage and processing speed; and
a programmable logic unit configured for adjusting operating voltage for the portable computing device to minimize power consumption while providing a desired processing speed as the operating temperature varies.

40. The system of claim 39, wherein the sensor comprises a thermistor.

41. The system of claim 39, wherein the sensor comprises a digital thermometer.

42. The system of claim 39, comprising a control program configured to calculate a desired operating voltage as a function of the operating temperature and based on the control criteria and the desired processing speed.

43. The system of claim 39, wherein the sensor is disposed on a processor for the portable computing device.

44. The system of claim 39, wherein the programmable logic unit is coupled to a power supply for the portable computing device.

45. The system of claim 39, wherein the programmable logic unit is coupled to a battery for the portable computing device.
